(19) United States
(12) Patent Application Publication
(10) Pub. No.: US 2023/0289762 A1
(43) Pub. Date: Sep. 14, 2023

(54) CHECKOUT DEVICE AND PROGRAM

(71) Applicant: TOSHIBA TEC KABUSHIKI KAISHA, Tokyo (JP)

(72) Inventors: Hiroyuki Ishikawa, Sunto Shizuoka (JP); Sadatoshi Oishi, Fuji Shizuoka (JP)

(21) Appl. No.: 17/985,173

(22) Filed: Nov. 11, 2022

(30) Foreign Application Priority Data
Mar. 8, 2022 (JP) 2022-034903

(51) Int. Cl. G06Q 20/20; G06Q 20/18

(52) U.S. Cl. CPC G06Q 20/208; G06Q 20/18

(57) ABSTRACT

A self-service checkout device in an embodiment includes a first antenna capable of moving in a predetermined distance and configured to read tag information from a wireless tag attached to a commodity, a first processing unit configured to, if receiving a trigger signal, move the first antenna and perform commodity registration processing for the commodity based on the read tag information, and a second processing unit configured to perform other processing relating to operation in parallel to the commodity registration processing performed by the first processing unit.

### CROSS-REFERENCE TO RELATED APPLICATION

This application is based upon and claims the benefit of priority from Japanese Patent Application No. 2022-034903, filed on Mar. 8, 2022, the entire contents of which are incorporated herein by reference.

### FIELD

Embodiments described herein relate generally to a checkout device and a program.

### BACKGROUND

In a retail store such as a supermarket or a convenience store, a checkout device with which a store clerk or a customer performs sales registration operation and checkout operation has been used. For example, in a self-service checkout device with which a customer performs sales registration operation and checkout operation by himself or herself, the customer places a commodity or a basket or the like storing the commodity on a placing table. Then, the customer performs operation relating to the commodity. The customer performs, for example, operation for starting the self-service checkout device, operation for determining necessity of a shopping bag, and operation for selecting a payment method. If these kinds of operation are performed, the self-service checkout device performs kinds of processing corresponding to the kinds of operation. Before and after these kinds of processing, the self-service checkout device reads tag information from a wireless tag attached to the commodity and performs commodity registration processing. The same operation and the same processing are performed in a checkout device operated by a store clerk. The checkout device finally performs checkout processing for the registered commodity.

As explained above, the checkout device performs various kinds of processing from the start of the operation to the checkout processing and performs the commodity registration processing (these kinds of processing are collectively referred to as “register processing”). Therefore, a time for the register processing required for one customer is sometimes long. In particular, in the case of the self-service checkout device, since the customer performs the operation from the start to the end, a time of the register processing required for one customer tends to be long.

### DESCRIPTION OF THE DRAWINGS

FIG. 1 is an exterior perspective view of a self-service checkout device according to a first embodiment;

FIG. 2 is an explanatory diagram illustrating a configuration of a reading device;

FIG. 3 is a block diagram illustrating a hardware configuration of the self-service checkout device;

FIG. 4 is a block diagram illustrating a hardware configuration of the reading device;

FIG. 5 is a functional block diagram illustrating a functional configuration of the self-service checkout device;

FIG. 6 is a flowchart illustrating a flow of control processing of the reading device;

FIG. 7 is a flowchart illustrating a flow of control processing of the self-service checkout device;

FIG. 8 is a flowchart illustrating a flow of commodity registration processing in the self-service checkout device;

FIG. 9 is a diagram illustrating parallel processing of the commodity registration processing and other processing in the self-service checkout device;

FIG. 10 is a block diagram illustrating a hardware configuration of a self-service checkout device in a second embodiment;

FIG. 11 is a flowchart illustrating a flow of control processing of a reading device;

FIG. 12 is a flowchart illustrating a flow of control processing of the self-service checkout device;

FIG. 13 is an explanatory diagram illustrating a configuration of a reading device in a third embodiment;

FIG. 14 is a block diagram illustrating a hardware configuration of a self-service checkout device; and

FIG. 15 is a flowchart illustrating a flow of control processing of the self-service checkout device.

### DETAILED DESCRIPTION

An aspect of embodiments is to provide a checkout device and a program capable of reducing a time of register processing required for one customer.

A self-service checkout device in an embodiment includes: a first antenna capable of moving in a predetermined distance and configured to read tag information from a wireless tag attached to a commodity; a first processing unit configured to, if receiving a trigger signal, move the first antenna and perform commodity registration processing for the commodity based on the read tag information; and a second processing unit configured to perform other processing relating to operation in parallel to the commodity registration processing performed by the first processing unit.

### First Embodiment

A first embodiment is explained below. A self-service checkout device according to the first embodiment is an example of a checkout device (POS (Point of Sales) terminal) set in a store such as a supermarket, a convenience store, and a volume retailer. The self-service checkout device is used for commodity registration processing and checkout processing for commodities sold in the store. With the self-service checkout device, a customer performs commodity registration operation and checkout operation by himself or herself. If the customer performs the commodity registration operation, the self-service checkout device performs the commodity registration processing. If the customer performs the checkout operation, the self-service checkout device performs the checkout processing.

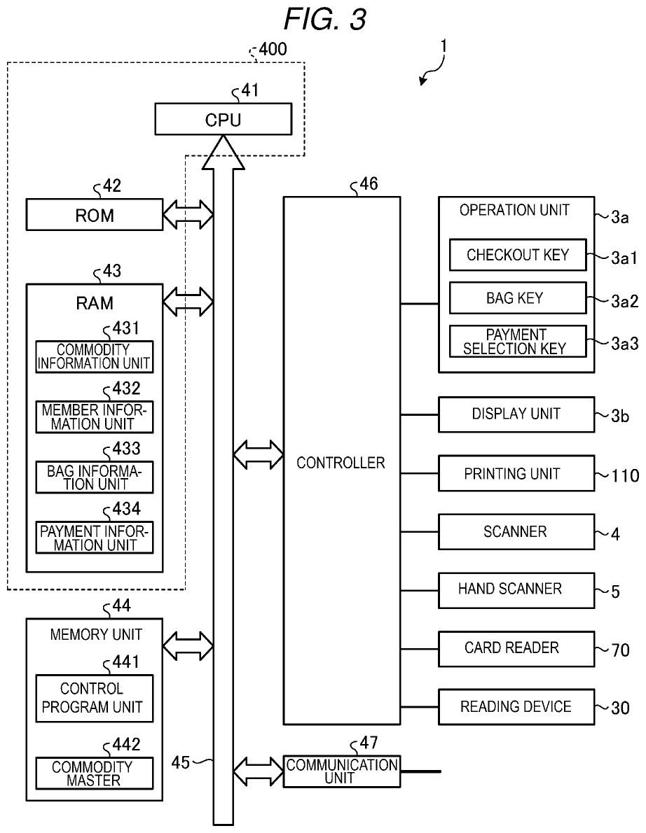

The commodity registration processing means processing for acquiring commodity specifying information relating to a commodity to be sold, displaying, on a display unit, a commodity name and a price (commodity information) of the commodity acquired based on the acquired commodity specifying information, and storing the commodity information in a commodity information unit 431 (see FIG. 3). The checkout processing means, for example, processing for displaying a total amount relating to a relevant transaction based on the commodity information stored in the commodity information unit 431 according to the commodity registration processing, settlement processing by a medium such as cash or a credit card, processing for calculating change based on deposited money and displaying the change in the case of cash settlement, processing for instructing a change machine to dispense the change, and processing for dispensing, from a printing unit, a receipt on which the commodity information and checkout information (the total amount, a deposit amount, a change amount, and the like) are printed.

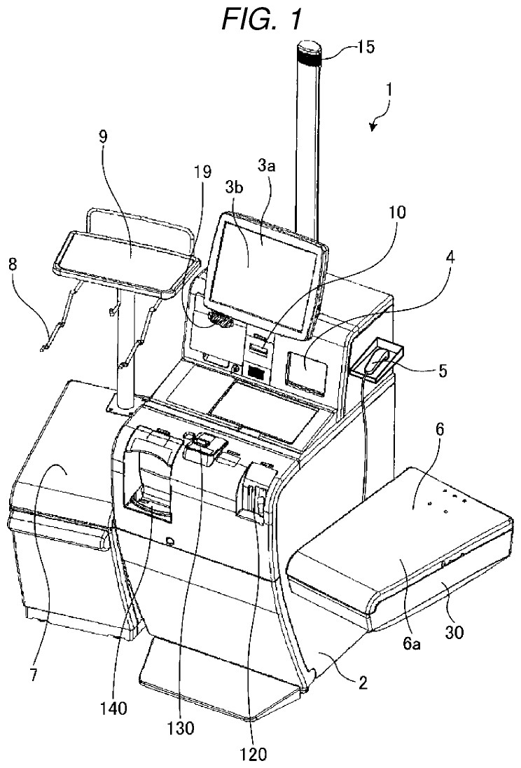

FIG. 1 is an exterior perspective view of a self-service checkout device 1 according to the first embodiment. A main body 2 of the self-service checkout device 1 includes a display unit 3b, a scanner 4, and a hand scanner 5 in an upper part. The scanner 4 and the hand scanner 5 are devices that optically read or image and read a code symbol including commodity specifying information such as a barcode or a two-dimensional code attached to a commodity to which a wireless tag explained below cannot be stuck. An operation unit 3a configured by a touch panel is disposed on the surface of the display unit 3b.

For example, a liquid crystal display is used as the display unit 3b. The display unit 3b displays a guidance screen for informing a customer of an operation method for the self-service checkout device 1. The display unit 3b displays commodity information of a commodity subjected to commodity registration processing. The operation unit 3a is a keyboard that, if positions corresponding to images of various keys displayed on the display unit 3b are touched (operated), functions as the keys.

A card insertion port 10 for inserting a card such as a point card or a credit card of a customer at a settlement time is provided in the main body 2 of the self-service checkout device 1. The credit card stores customer specifying information and is inserted if the customer selects card settlement as a type of settlement. A receipt dispensing port 19 for dispensing a receipt is provided in the main body 2. Further, a bill depositing and dispensing port 120 for depositing bills for settlement and receiving change bills is provided in the main body 2. In addition, a coin depositing port 130 for depositing coins at the settlement time, a coin dispensing port 140 for receiving change coins, and the like are provided in the main body 2. Further, a pole is provided on the upper surface of the main body 2. An alarm lamp 15 that is lit, for example, if an abnormality occurs in operation in the self-service checkout device 1 or if the customer calls a store clerk is provided in an upper part of the pole.

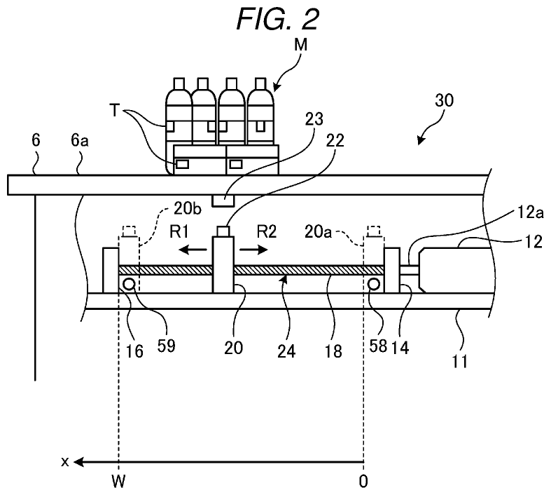

A commodity placing table 6 for placing unsettled commodities put in a basket (or placing a basket storing the commodities) is provided on the right side of the main body 2. A reading device 30 is provided in the commodity placing table 6. The reading device 30 is a device that receives tag information (a radio wave) transmitted from a wireless tag T (see FIG. 2) attached to a commodity placed on an upper surface 6a of the commodity placing table 6 (for example, a commodity stored in a basket (not illustrated) placed on the upper surface 6a). The tag information includes commodity specifying information for specifying, in an individual item unit, the commodity to which the wireless tag T is stuck. In the following explanation, the reading device 30 receiving the tag information with an antenna is referred to as the reading device 30 reading the tag information. The display unit 3b displays commodity information of the commodity subjected to commodity registration processing and specified based on the read tag information.

Subsequently, a configuration of the reading device 30, which is a part of the self-service checkout device 1, is explained. FIG. 2 is an explanatory diagram illustrating a schematic configuration of the reading device 30. The reading device 30 is set on the inside of the commodity placing table 6. The reading device 30 is set in a position opposed to a placing position of commodities M placed on the upper surface 6a. The reading device 30 reads tag information transmitted by wireless tags T attached to the commodities M placed on the upper surface 6a. In FIG. 2, the commodities M are directly placed on the upper surface 6a. However, a basket storing the commodities M may be placed on the upper surface 6a.

The reading device 30 reads the wireless tags T attached to the commodities M, in the embodiment, tag information stored in the wireless tags T operating in, in particular, a UHF band. The reading device 30 includes a first antenna 22 and a second antenna 23. The first antenna 22 is embedded in the commodity placing table 6 as illustrate in FIG. 2. The first antenna 22 is, for example, a plane patch antenna directed to the upper surface 6a. The second antenna 23 is embedded in the commodity placing table 6. The second antenna 23 is, for example, a plane patch antenna directed to the upper surface 6a. The second antenna 23 is fixedly provided, for example, in a position on the rear side of the upper surface 6a of the commodity placing table 6 and near the placing position of the commodities M.

The reading device 30 radiates a radio wave from the first antenna 22 and the second antenna 23. The reading device 30 receives, with the first antenna 22 and the second antenna 23, tag information transmitted from the wireless tags T.

Specifically, the reading device 30 radiates, via the first antenna 22 and the second antenna 23, a radio wave including information for instructing transmission of tag information. The wireless tags T that receive the radio wave transmit tag information stored in the wireless tags T in advance (information including tag IDs for specifying the tags T and commodity specifying information for specifying, as individual items, the commodities M to which the wireless tags T are attached) to the reading device 30. The reading device 30 receives the tag information from the wireless tags T with the first antenna 22 and the second antenna 23 and stores the tag information received by the first antenna 22. The reading device 30 outputs, at timing when the second antenna 23 receives the tag information, a signal indicating that the tag information is received. The reading device 30 outputs the tag information read by the first antenna 22 and stored. The second antenna 23 has weaker transmission power than the first antenna 22 and continuously or intermittently performs transmission.

The first antenna 22 is set to be capable of moving, with a moving mechanism 24 (a movable unit) disposed on the inside of the commodity placing table 6, in parallel along the upper surface 6a in the commodity placing table 6.

The moving mechanism 24 is configured by a linear motion mechanism including a screw shaft 18, a bearing 16 of the screw shaft 18, a stepping motor 12, a coupling 14, and a moving stage 20. The stepping motor 12 is a rotation power source. The coupling 14 transmits rotation power of the stepping motor 12 to the screw shaft 18. The moving stage 20 is configured integrally with a ball screw nut screwed with the screw shaft 18. The first antenna 22 is fixedly provided in the moving stage 20.

The screw shaft 18 is horizontally supported to be capable of axially rotating by the bearing 16 at one end and by the coupling 14 at the other end. An output shaft 12a of the stepping motor 12 is connected to the screw shaft 18 in the coupling 14. With this configuration, the rotation power of the stepping motor 12 is transmitted from the output shaft 12a to the screw shaft 18 via the coupling 14.

The moving stage 20 includes a through-hole in a main body. The ball screw nut of the screw shaft 18 is embedded in the through-hole. If the ball screw nut is screwed with the screw shaft 18, the moving stage 20 is capable of moving in the axial direction of the screw shaft 18 according to the rotation of the screw shaft 18, that is, capable of moving in the directions of an arrow R1 and an arrow R2 illustrated in FIG. 2. It is assumed that the moving stage 20 is capable of moving between x=0 and x=W (in a predetermined distance) along an x axis illustrated in FIG. 2. That is, the moving stage 20 is capable of moving between a rightmost position 20a and a leftmost position 20b.

As explained above, the moving mechanism 24 changes a rotational motion of the stepping motor 12 into a linear motion with a ball screw mechanism explained above and enables the movement of the moving stage 20. The moving stage 20 slides while bringing a part of the main body into contact with a supporting plate 11 to prevent the main body itself from turning according to the rotation of the screw shaft 18. Consequently, the moving stage 20 moves in the directions of the arrow R1 and the arrow R2 while keeping a posture constant.

On a main body upper surface of the moving stage 20, the first antenna 22 is fixed with a reading surface of the first antenna 22 directed to the upper surface 6a. The reading surface indicates a radiation surface from which the plane patch antenna radiates a radio wave. With this disposition, the first antenna 22 radiates a radio wave from the front of the reading surface, that is, the upper surface 6a to the wireless tag T attached to a commodity placed on the commodity placing table 6. The first antenna 22 moves in the directions of the arrow R1 and the arrow R2 substantially between x=0 and x=W along the screw shaft 18 and along the x axis integrally with the moving stage 20.

The reading device 30 includes, in a moving route of the moving stage 20, a position sensor 58 (for example, a microswitch or an optical sensor) and a position sensor 59 (for example, a microswitch and an optical sensor). The position sensor 58 detects that the moving stage 20 (that is, the first antenna 22) is located in a home position (a position of x=0). The position sensor 58 outputs a signal if the moving stage 20 (that is, the first antenna 22) is located in the home position. The home position is a position where the moving stage 20 (that is, the first antenna 22) starts to move. The position sensor 59 detects that the moving stage 20 (the is, the first antenna 22) is located in a position of x=W. The position sensor 59 outputs a signal if the moving stage 20 (that is, the first antenna 22) is located in the position of x=W. The moving stage 20 (that is, the first antenna 22) starts movement in the R1 direction from the home position. If the position sensor 59 detects the moving stage 20, the position sensor 59 stops the movement in the R1 direction of the moving stage 20 and moves the moving stage 20 in the R2 direction. If the position sensor 58 detects the moving stage 20, the position sensor 58 stops the movement in the R2 direction of the moving stage 20. The moving stage 20 is located in the home position. The reading device 30 performs processing for reading tag information while moving the first antenna 22. In the embodiment, a moving range of the moving stage 20 is specified by the position sensor 58 and the position sensor 59. However, the moving range of the moving stage 20 may be specified using, for example, a linear encoder that measures linear axis movement and outputs position information.

By reading the tag information while moving the first antenna 22 in this way, it is easy to read, for example, tag information of the wireless tag T that is hidden by another commodity M and less easily receives a radio wave. In addition, by reading the tag information while moving the first antenna 22, it is possible to store only tag information of the wireless tag T attached to the commodity M placed on the commodity placing table 6 of the self-service checkout device 1 itself without storing tag information of the wireless tag T that should not originally be read (for example, that is located at a distance) even if the tag information is read.

A method of storing only the tag information of the wireless tag T attached to the commodity M placed on the commodity placing table 6 of the self-service checkout device 1 itself is explained. If the first antenna 22 moves, the distance between the first antenna 22 and the wireless tag T attached to the commodity M changes. If the distance between the first antenna 22 and the wireless tag T changes, a phase of the tag information read by the first antenna 22 changes. A change amount of the phase of the tag information due to the movement of the first antenna 22 is calculated using this characteristic. If the first antenna 22 moves the same distance, the distance between the first antenna 22 and a wireless tag located near the first antenna 22 greatly changes and the distance between the first antenna 22 and a wireless tag located far from the first antenna 22 does not change so greatly. Therefore, a change amount of a phase of tag information received from the wireless tag located near the first antenna 22 is larger than a change amount of a phase of tag information received from the wireless tag located far from the first antenna 22. In other words, if the first antenna 22 moves the same distance, the wireless tag T having a larger change amount of a phase is located in a position closer to the first antenna 22 and the wireless tag T having a smaller change amount of a phase is located in a position farther from the first antenna 22.

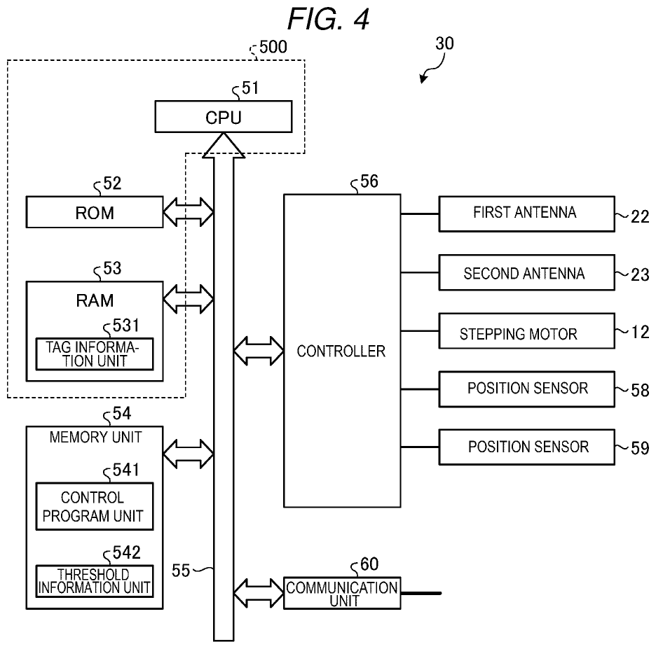

A boundary value between a change amount of a phase of tag information of the wireless tag T attached to the commodity M placed on the commodity placing table 6 of the self-service checkout device 1 itself and a change amount of a phase of tag information of the wireless tag T attached to the commodity M placed on the commodity placing table 6 of another self-service checkout device 1 is stored in a threshold information unit 542 (see FIG. 4) in advance as a threshold. If a change amount of a phase of received tag information is larger than the threshold, the tag information is regarded as tag information received from the wireless tag T attached to the commodity M placed on the commodity placing table 6 of the self-service checkout device 1 itself and is stored. On the other hand, if a change amount of a phase of received tag information is smaller than the threshold, the tag information is regarded as tag information received from the wireless tag T attached to the commodity M placed on the commodity placing table 6 of the self-service checkout device 1 other than the self-service checkout device 1 itself and is not stored. In this way, the self-service checkout device 1 extracts, from the read tag information, the wireless tag T attached to the commodity M placed on the commodity placing table 6 of the self-service checkout device 1 itself.

The self-service checkout device 1 may extract, from the read tag information, the wireless tag T attached to the commodity M placed on the commodity placing table 6 of the self-service checkout device 1 itself using a machine learning technology as explained below. That is, the self-service checkout device 1 collects data relating to a distance that the first antenna 22 moves and a change amount of a phase of read tag information of the wireless tag T to machine-learn, according to the change amount of the phase of the read tag information, whether the wireless tag T is the wireless tag T relating to the commodity M placed on the commodity placing table 6 of the self-service checkout device 1 itself. As a larger number of data are collected, more correct machine learning can be performed. The self-service checkout device 1 generates a learning model for determining whether the wireless tag T is the wireless tag T relating to the commodity M placed on the commodity placing table 6 of the self-service checkout device 1 itself. The self-service checkout device 1 stores the generated learning model in the threshold information unit 542. By using the learning model, the self-service checkout device 1 extracts, from the read tag information, the wireless tag T attached to the commodity M placed on the commodity placing table 6 of the self-service checkout device 1 itself.

A hardware configuration of the self-service checkout device 1 is explained below. FIG. 3 is a block diagram illustrating the hardware configuration of the self-service checkout device 1. As illustrated in FIG. 3, the self-service checkout device 1 includes a CPU (Central Processing Unit) 41, a ROM (Read Only Memory) 42, a RAM (Random Access Memory) 43, and a memory unit 44. The CPU 41 is a control entity of the self-service checkout device 1. The ROM 42 stores various programs. Programs and various data are loaded in the RAM 43. The memory unit 44 stores various programs. The CPU 41, the ROM 42, the RAM 43, and the memory unit 44 are connected to one another via a bus 45. The CPU 41, the ROM 42, and the RAM 43 configure a control unit 400. That is, the CPU 41 operates according to a control program stored in the ROM 42 or the memory unit 44 and loaded in the RAM 43, whereby the control unit 400 executes control processing of the self-service checkout device 1 explained below.

The RAM 43 includes a commodity information unit 431, a member information unit 432, a bag information unit 433, and a payment information unit 434. The commodity information unit 431 stores commodity information (a commodity name, a commodity price, and the like) of the commodity M subjected to commodity registration processing and acquired from a commodity master 422 based on commodity specifying information or the like stored in read tag information. The member information unit 432 stores customer specifying information read by a card reader 70 explained below. If a bag key 3a2 explained below is operated, the bag information unit 433 stores bag information (information indicating the size and the number of bags) of a bag for storing the commodity M. The payment information unit 434 stores payment information (information concerning, for example, cash payment, credit card payment, and prepaid card payment) indicating a selected payment method.

The memory unit 44 is configured by a nonvolatile memory such as a HDD (Hard Disc Drive) or a flash memory in which stored information is maintained even if the self-service checkout device 1 is turned off. The memory unit 44 includes a control program unit 441 that stores a control program and a commodity master 442. The commodity master 442 stores commodity information of the commodities M in association with commodity specifying information for specifying the commodities M.

The control unit 400 is connected to the operation unit 3a, the display unit 3b, the printing unit 110, the scanner 4, the hand scanner 5, the card reader 70, and the reading device 30 via the bus 45 and a controller 46.

The operation unit 3a includes a checkout key 3a1, a bag key 3a2, and a payment selection key 3a3. The checkout key 3a1 is a key that a customer operates in advancing processing to checkout processing in the self-service checkout device 1. The bag key 3a2 is a key that the customer operates in purchasing a bag for storing a purchased commodity M. If the bag key 3a2 is operated, a screen for selecting a size and the number of bags to be purchased is displayed. Therefore, the customer selects a size of a necessary bag and inputs a numerical value indicating the number of bags. The payment selection key 3a3 is a key for selecting means (cash, a credit card, a prepaid card, or the like) for performing checkout processing. If the payment selection key 3a3 is operated, a selection screen for a medium (cash, a credit card, a prepaid card, or the like) for performing the checkout processing is displayed. The customer selects a medium for performing checkout out of displayed media and operates the medium.

The display unit 3b displays images of various keys to be operated, commodity information of the commodity M subjected to commodity registration processing, checkout information subjected to checkout processing, and the like. The printing unit 110 dispenses, from the receipt dispensing port 19, a receipt on which the commodity information, the checkout information, and the like are printed. The scanner 4 and the hand scanner 5 read a code symbol attached to a commodity to which the wireless tag T is not stuck (for example, a heavy commodity or a commodity to which it is physically difficult to stick the wireless tag T). The card reader 70 magnetically or electrically reads information of various cards inserted from the card insertion port 10. The controller 46 receives an instruction from the control unit 400 and controls the operation unit 3a, the display unit 3b, the printing unit 110, the scanner 4, the hand scanner 5, the card reader 70, and the reading device 30. However, for convenience of explanation, it is assumed that control performed by the controller 46 is performed by the control unit 400.

The control unit 400 is connected to the communication unit 47 via the bus 45. The communication unit 47 is electrically connected to the other self-service checkout devices 1 via a communication line.

FIG. 4 is a block diagram illustrating a hardware configuration of the reading device 30. As illustrated in FIG. 4, the reading device 30 includes a CPU 51, a ROM 52, a RAM 53, and a memory unit 54. The CPU 51 is a control entity of the reading device 30. The ROM 52 stores various programs. Programs and various data are loaded in the RAM 53. The memory unit 54 stores various programs. The CPU 51, the ROM 52, the RAM 53, and the memory unit 54 are connected to one another via a bus 55. The CPU 51, the ROM 52, and the RAM 53 configure a control unit 500. That is, the CPU 51 operates according to a control program stored in the ROM 52 or the memory unit 54 and loaded in the RAM 53, whereby the control unit 500 executes control processing of the reading device 30 explained below.

The RAM 53 includes a tag information unit 531. The tag information unit 531 stores tag information read by the first antenna 22 from the wireless tag T.

The memory unit 54 is configured by a nonvolatile memory such as a HDD or a flash memory in which stored information is maintained even if the reading device 30 is turned off. The memory unit 54 includes a control program unit 541 that stores a control program and a threshold information unit 542. The threshold information unit 542 stores a threshold of a change amount of a phase of tag information for identifying whether the wireless tag T is the wireless tag T attached to the commodity M placed on the commodity placing table 6 of the self-service checkout device 1 including the reading device 30 or the wireless tag T attached to the commodity M located in a position other than the commodity placing table 6 of a device other than the self-service checkout device 1 including the reading device 30. If a change amount of a phase of read tag information is larger than the threshold of the change amount of the phase stored in the threshold information unit 542, the control unit 500 determines that the wireless tag T of the tag information is the wireless tag T attached to the commodity M placed on the commodity placing table 6 of the self-service checkout device 1 including the reading device 30. If a change amount of a phase of read tag information is smaller than the threshold of the change amount of the phase stored in the threshold information unit 542, the control unit 500 determines that the wireless tag T of the tag information is the wireless tag T attached to the commodity M located in a position other than the commodity placing table 6 of the self-service checkout device 1 including the reading device 30.

The control unit 500 is connected to the first antenna 22, the second antenna 23, the stepping motor 12, the position sensor 58, and the position sensor 59 via the bus 55 and a controller 56.

The control unit 500 is connected to the communication unit 60 via the bus 55. The communication unit 60 is electrically connected to the controller 56 via a communication line.

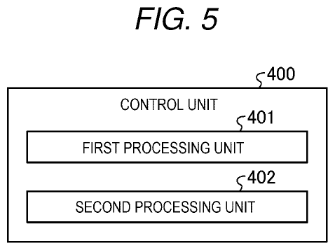

A functional configuration of the self-service checkout device 1 according to the first embodiment is explained. FIG. 5 is a functional block diagram illustrating the functional configuration of the self-service checkout device 1. The control unit 400 follows a control program stored in the ROM 42 or the control program unit 441 of the memory unit 44 to function as a first processing unit 401 and a second processing unit 402.

If receiving a trigger signal, the first processing unit 401 moves the first antenna 22 and performs commodity registration processing for the commodity M based on read tag information. Specifically, if receiving a trigger signal, the first processing unit 401 causes the reading device 30 to move the moving stage 20 mounted with the first antenna 22 between the rightmost position 20a and the leftmost position 20b and performs the commodity registration processing for the commodity M based on tag information read by the first antenna 22. The first processing unit 401 performs the commodity registration processing for the commodity M stuck with the wireless tag T having tag information, a change amount of a phase of which is larger than the threshold stored in the threshold information unit 542, in the tag information read by the first antenna 22.

The first processing unit 401 moves the first antenna 22 using, as a trigger signal, information indicating that the second antenna 23 received the tag information and performs the commodity registration processing for the commodity M based on the read tag information. If the commodity M is placed on the commodity placing table 6 of the self-service checkout device 1 itself, since the second antenna 23 reads tag information, the first processing unit 401 treats, as a trigger signal, the tag information read by the second antenna 23.

The second processing unit 402 performs other processing relating to operation in parallel to the commodity registration processing performed by the first processing unit 401. Specifically, the second processing unit 402 performs other processing relating to operation in parallel to the processing for moving the first antenna 22 performed by the first processing unit 401 and the commodity registration processing based on the read wireless tag T. In the first embodiment, the member processing for reading a member card and storing customer specifying information, the processing for storing, based on input information concerning necessity of a bag, a size and the number of bags to be purchased, and the processing for storing a selected payment method are stored as the other processing relating to operation in parallel to the processing for moving the first antenna 22 performed by the first processing unit 401 and the commodity registration processing based on the read wireless tag T.

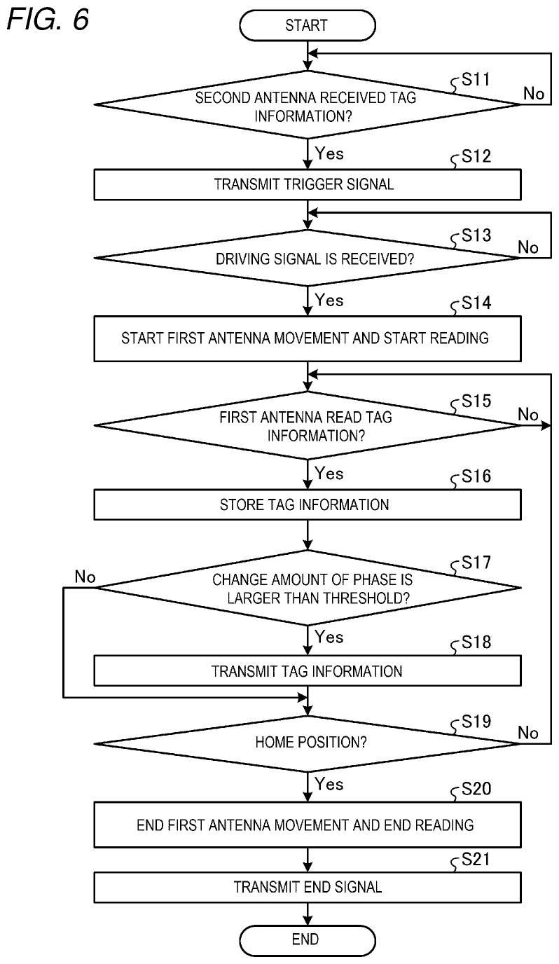

Control of the self-service checkout device 1 according to the first embodiment is explained below. FIG. 6 is a flowchart illustrating a flow of control processing of the reading device 30. As illustrated in FIG. 6, the control unit 500 of the reading device 30 determines whether the second antenna 23 read tag information transmitted from the wireless tag T (Act 11). The control unit 500 stays on standby until the second antenna 23 reads the tag information (No in Act 11). If determining that the second antenna 23 read the tag information (Yes in Act 11), the control unit 500 transmits a trigger signal indicating that the second antenna 23 read the tag information to the controller 56 via the communication unit 60 (Act 12).

Subsequently, the control unit 500 determines whether a driving signal by processing in Act 32 explained below is received (Act 13). The control unit 500 stays on standby until a driving signal is received (No in Act 13). If the control unit 500 determines that the driving signal is received (Yes in Act 13), the first processing unit 401 drives the stepping motor 12 and starts moving the moving stage 20 (that is, the first antenna 22) from the home position (that is, x=0) in the arrow R1 direction (Act 14). At the same time, the first processing unit 401 radiates a radio wave from the first antenna 22 and starts reading, with the first antenna 22, the tag information transmitted from the wireless tag T (Act 14).

Subsequently, the control unit 500 determines whether the first antenna 22 read the tag information (Act 15). The control unit 500 stays on standby until the first antenna 22 reads the tag information (No in Act 15). If determining that the first antenna 22 read the tag information (Yes in Act 15), the control unit 500 stores the read tag information in the tag information unit 531 (Act 16). If the tag information is already stored in the tag information unit 531, the control unit 500 calculates a change amount of a phase between the tag information already stored in the tag information unit 531 and the stored tag information and determines whether the change amount is larger than the threshold stored in the threshold information unit 542 (Act 17). If determining that the change amount is larger than the threshold stored in the threshold information unit 542 (Yes in Act 17), the control unit 500 transmits the stored tag information to the controller 56 via the communication unit 60 (Act 18). If determining that the change amount is smaller than the threshold stored in the threshold information unit 542 (No in Act 17), the control unit 500 does not transmit the stored tag information to the controller 56 (does not execute the processing in Act 18). If the change amount is equal to the threshold stored in the threshold information unit 542, the control unit 500 determines that the change amount is larger than the threshold stored in the threshold information unit 542.

Subsequently, the control unit 500 determines whether the first antenna 22 moved to the home position (the position of x=0) (Act 19). If determining that the first antenna 22 did not move to the home position yet (No in Act 19), the control unit 500 returns to Act 15 and repeats the processing in Act 15 to Act 19. On the other hand, if the control unit 500 determines that the first antenna 22 moved to the home position (Yes in Act 19), the first processing unit 401 stops the driving of the stepping motor 12 and ends the movement of the moving stage 20 (that is, the first antenna 22) (Act 20). At the same time, the first processing unit 401 stops the radiation of the radio wave from the first antenna 22 and ends the reading by the first antenna 22 of the tag information transmitted from the wireless tag T (Act 20). The control unit 500 transmits an end signal indicating that the reading of the tag information ended to the controller 56 via the communication unit 60 (Act 21). The control unit 500 ends the processing.

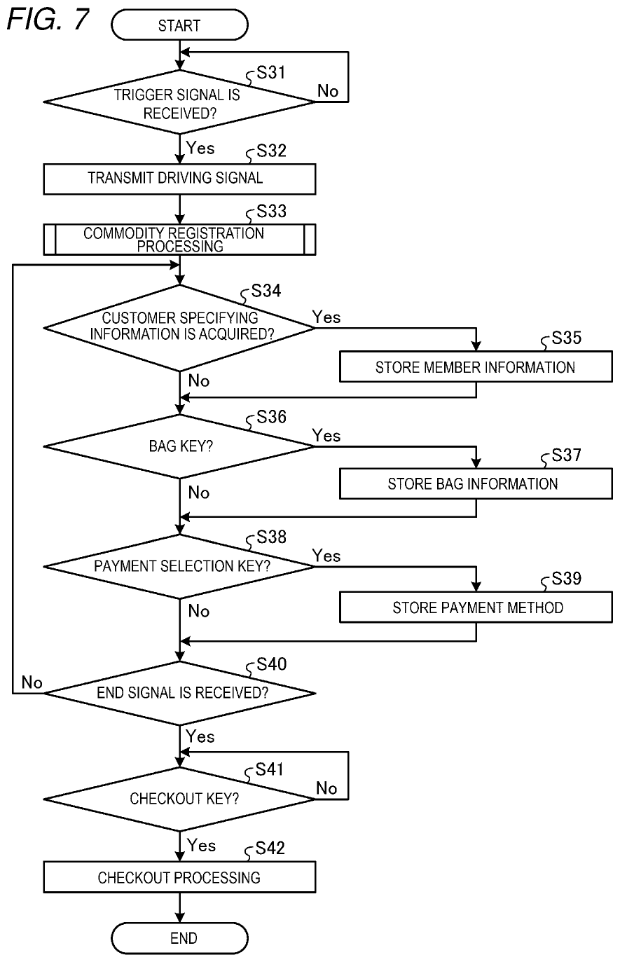

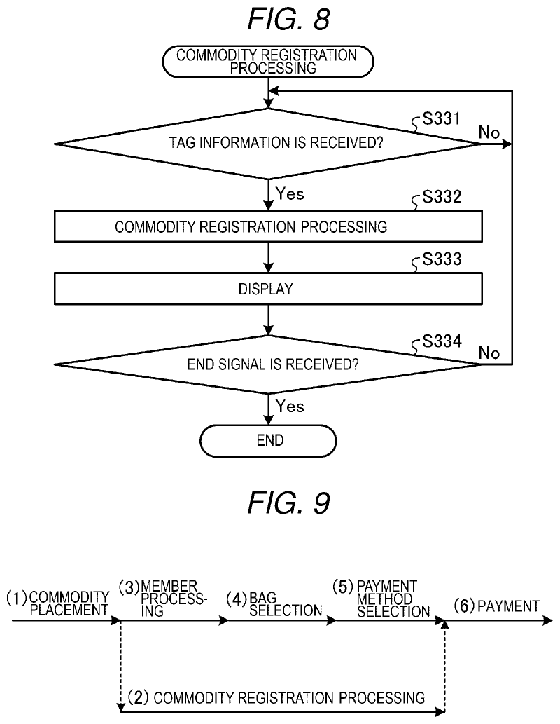

Control of the self-service checkout device 1 is explained below. FIG. 7 is a flowchart illustrating a flow of control processing of the self-service checkout device 1. FIG. 8 is a flowchart illustrating a flow of commodity registration processing in the self-service checkout device 1. As illustrated in FIG. 7, the control unit 400 of the self-service checkout device 1 determines whether the trigger signal by the processing in Act 12 of the reading device 30 is received (Act 31). The control unit 400 stays on standby until the trigger signal is received (No in Act 31). If determining that the trigger signal is received (Yes in Act 31), the control unit 400 transmits a driving signal to the reading device 30 (Act 32). The control unit 400 executes, as a subroutine, the commodity registration processing illustrated in FIG. 8 (Act 33).

In FIG. 8, the control unit 400 determines whether the tag information transmitted in the processing in Act 18 is received from the reading device 30 (Act 331). The control unit 400 stays on standby until the tag information is received (No in Act 331). If the control unit 400 determines that the tag information is received from the reading device 30 (Yes in Act 331), the first processing unit 401 executes the commodity registration processing relating to the commodity M based on commodity specifying information included in the received tag information (Act 332). The control unit 400 displays, on the display unit 3b, commodity information of the commodity M (a commodity name, a price, and the like of the commodity M) subjected to the commodity registration processing (Act 333).

Subsequently, the control unit 400 determines whether an end signal involved in the processing in Act 21 is received from the reading device 30 (Act 334). If determining that the end signal is not received (No in Act 334), the control unit 400 returns to Act 331 and repeats the determination and the processing in Act 331 to Act 334. That is, the control unit 400 repeats the commodity registration processing based on tag information received thereafter. On the other hand, if determining that the end signal is received from the reading device 30 (Yes in Act 334), the control unit 400 ends the commodity registration processing executed as the subroutine.

Referring back to FIG. 7, subsequently, the control unit 400 determines whether the card reader 70 acquired member information including customer specifying information by reading data of a member card from a credit card, a point card, or the like inserted from the card insertion port 10 (Act 34). If determining that the member information is acquired (Yes in Act 34), the second processing unit 402 stores the acquired member information in the member information unit 432 (Act 35). In the processing in Act 35, the control unit 400 displays the stored member information on the display unit 3b.

If determining that the customer specifying information is not acquired (No in Act 34) and after the end of the processing in Act 35, the control unit 400 determines whether the bag key 3a2 is operated (Act 36). If the control unit 400 determines that the bag key 3a2 is operated (Yes in Act 36), the second processing unit 402 stores, in the bag information unit 433, information concerning a size and the number of bags input according to the operation of the bag key 3a2 (Act 37). In the processing in Act 37, the control unit 400 displays, on the display unit 3b, the stored information concerning the size and the number of bags.

If determining that the bag key 3a2 is not operated (No in Act 36) and after the end of the processing in Act 37, the control unit 400 determines whether the payment selection key 3a3 is operated (Act 38). If the control unit 400 determines that the payment selection key 3a3 is operated (Yes in Act 38), the second processing unit 402 stores, in the payment information unit 434, information concerning a payment method (information such as payment by cash, payment by a credit card, or payment by a prepaid card) selected according to the operation of the payment selection key 3a3 (Act 39). In the processing in Act 39, the control unit 400 displays the stored payment information on the display unit 3b.

After the processing in Act 39 and if determining that the payment selection key 3a3 is not operated (No in Act 38), the control unit 400 determines whether an end signal involved in the processing in Act 21 is received from the reading device 30 (Act 40). If determining that the end signal is not received (No in Act 40), the control unit 400 returns to Act 34 and repeats the determination and the processing in Act 34 to Act 40.

On the other hand, if determining that the end signal is received from the reading device 30 (Yes in Act 40), the control unit 400 determines that the checkout key 3a1 is operated (Act 41). The control unit 400 stays on standby until the checkout key 3a1 is operated (No in Act 41). If determining that the checkout key 3a1 is operated (Yes in Act 41), the control unit 400 executes checkout processing based on the commodity information stored in the commodity information unit 431 (Act 42). The control unit 400 ends the processing for the customer.

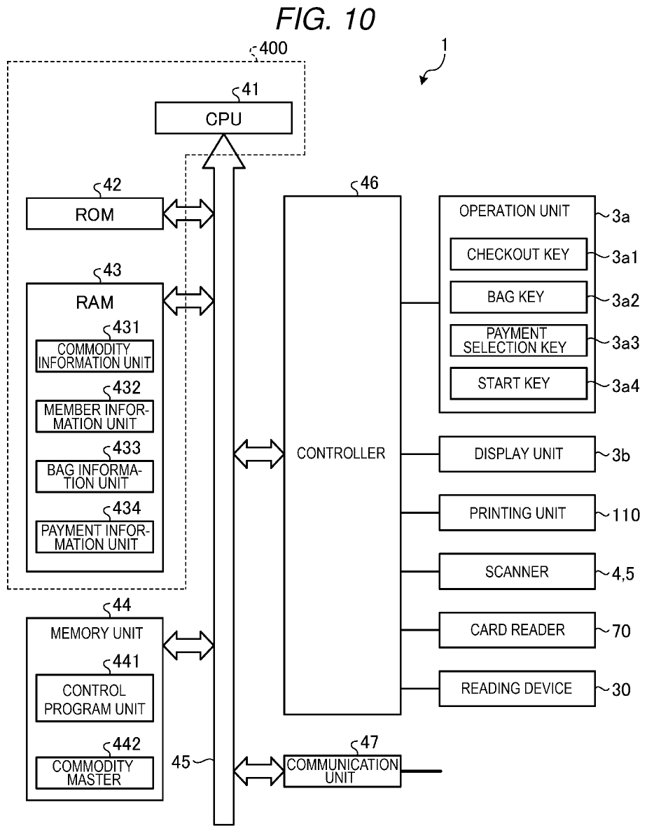

Such a self-service checkout device 1 in the first embodiment performs the commodity registration processing and the processing relating to the operation of the self-service checkout device 1 in parallel as illustrated in FIG. 9. That is, if the commodity M or a basket storing the commodity M is placed on the commodity placing table 6 (processing of (1) in FIG. 9), in the self-service checkout device 1, the second antenna 23 receives tag information transmitted by the wireless tag T attached to the commodity M. Then, the self-service checkout device 1 starts the commodity registration processing based on the tag information read by the first antenna 22 (processing of (2) in FIG. 9). Even during the commodity registration processing, if a card (a credit card, a point card, a member card, or the like) is inserted into the card insertion port 10, the self-service checkout device 1 performs member processing for reading customer specifying information from the card and storing the customer specifying information (processing of (3) in FIG. 9). Even during the commodity registration processing, if the bag key 3a2 is operated, the self-service checkout device 1 performs, based on input information concerning a size and the number of bags, processing for storing a size and the number of bags to be purchased (processing of (4) in FIG. 9). Even during the commodity registration processing, if the payment selection key 3a3 is operated, the self-service checkout device 1 performs processing for storing a selected payment method (processing of (5) in FIG. 9). That is, the self-service checkout device 1 performs the processing of (3), the processing of (4), and the processing of (5) in parallel to the processing of (2). Processing performed in parallel to the processing of (2) only has to be at least one of the processing of (3), the processing of (4), and the processing of (5). Thereafter, the self-service checkout device 1 performs payment processing (processing of (6) in FIG. 9).

As explained above, the self-service checkout device 1 in the first embodiment includes the first antenna 22 that is capable of moving in a predetermined distance and reads tag information from the wireless tag T attached to the commodity M, the first processing unit 401 that, if receiving a trigger signal generated by the second antenna 23 reading of the tag information, moves the first antenna 22 and performs commodity registration processing for the commodity M based on the read tag information, and the second processing unit 402 that performs other processing relating to operation in parallel to the commodity registration processing performed by the first processing unit 401.

If the commodity M or a basket storing the commodity M is placed on the commodity placing table 6, such a self-service checkout device 1 in the first embodiment performs, using, as a trigger signal, information obtained by the second antenna 23 reading the tag information, the commodity registration processing of (2) and at least one processing among the processing of (3), the processing of (4), and the processing of (5) in parallel. Therefore, it is possible to reduce a time of register processing required for one customer.

### Second Embodiment

A second embodiment is explained below. In the second embodiment, the same components as the components in the first embodiment are denoted by the same reference numerals and signs and explanation of the components is simplified or omitted.

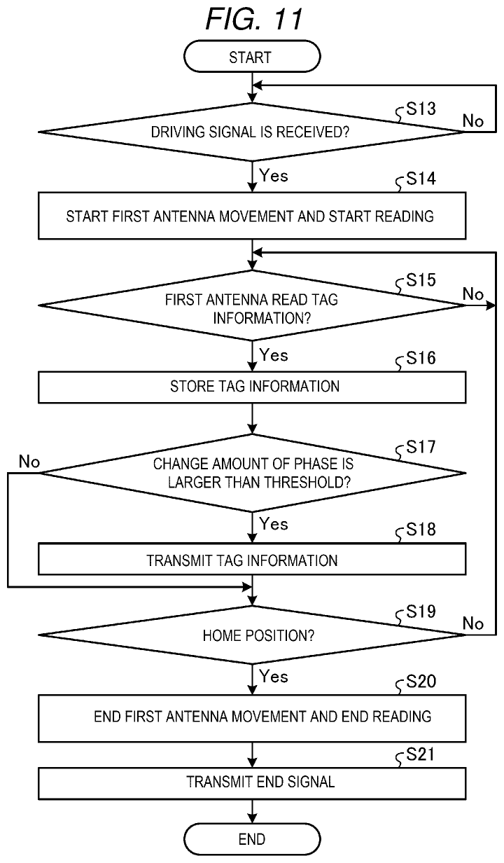

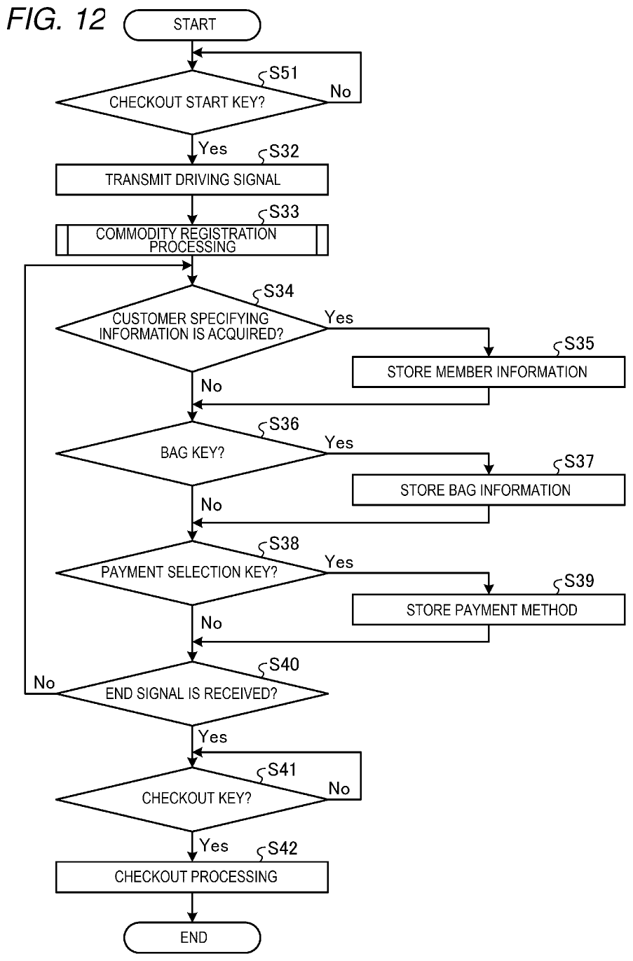

In the second embodiment, the reading device 30 does not include the second antenna 23 illustrated in FIG. 2. As illustrated in FIG. 10, the operation unit 3a includes a start key 3a4. A customer operates the start key 3a4 in starting operation in the self-service checkout device 1. If the start key 3a4 is operated, a trigger signal indicating that the start key 3a4 is operated is generated. As illustrated in FIG. 11, the control unit 500 of the reading device 30 does not execute the processing in Act 11 and the processing in Act 12 illustrated in FIG. 6. As illustrated in FIG. 12, as processing in Act 51, the control unit 400 of the self-service checkout device 1 determines whether the start key 3a4 is operated (Act 51). The control unit 400 stays on standby until the start key 3a4 is operated (No in Act 51). If determining that the start key 3a4 is operated (that is, if determining that the trigger signal is received) (Yes in Act 51), the control unit 400 transmits a driving signal to the reading device 30 (Act 32).

As explained above, the self-service checkout device 1 in the second embodiment includes the first antenna 22 that is capable of moving in a predetermined distance and reads tag information from the wireless tag T attached to the commodity M, the first processing unit 401 that, if receiving a trigger signal generated by the start key 3a4 being operated, moves the first antenna 22 and performs commodity registration processing for the commodity M based on the read tag information, and the second processing unit 402 that performs other processing relating to operation in parallel to the commodity registration processing performed by the first processing unit 401.

If the start key 3a4 is operated, such a self-service checkout device 1 in the second embodiment performs the commodity registration processing of (2) and at least one processing among the processing of (3), the processing of (4), and the processing of (5) illustrated in FIG. 9 in parallel. Therefore, it is possible to reduce a time of register processing required for one customer.

### Third Embodiment

A third embodiment is explained below. In the third embodiment, the same components as the components in the first embodiment are denoted by the same reference numerals and signs and explanation of the components is simplified or omitted.

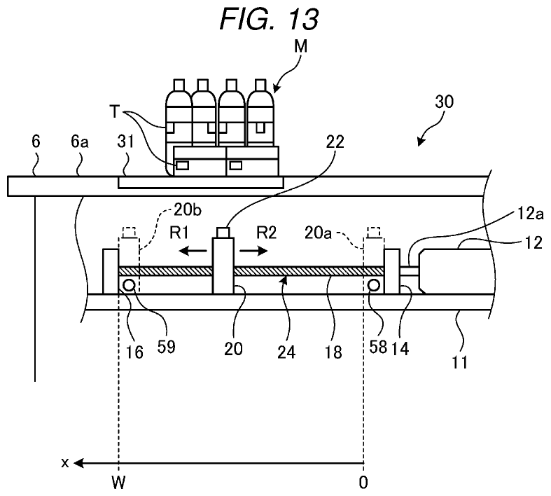

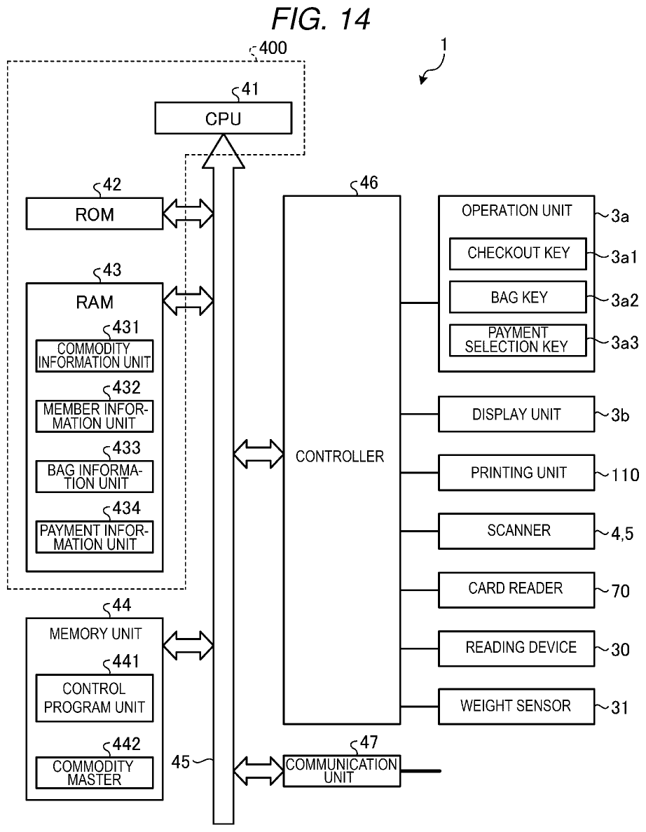

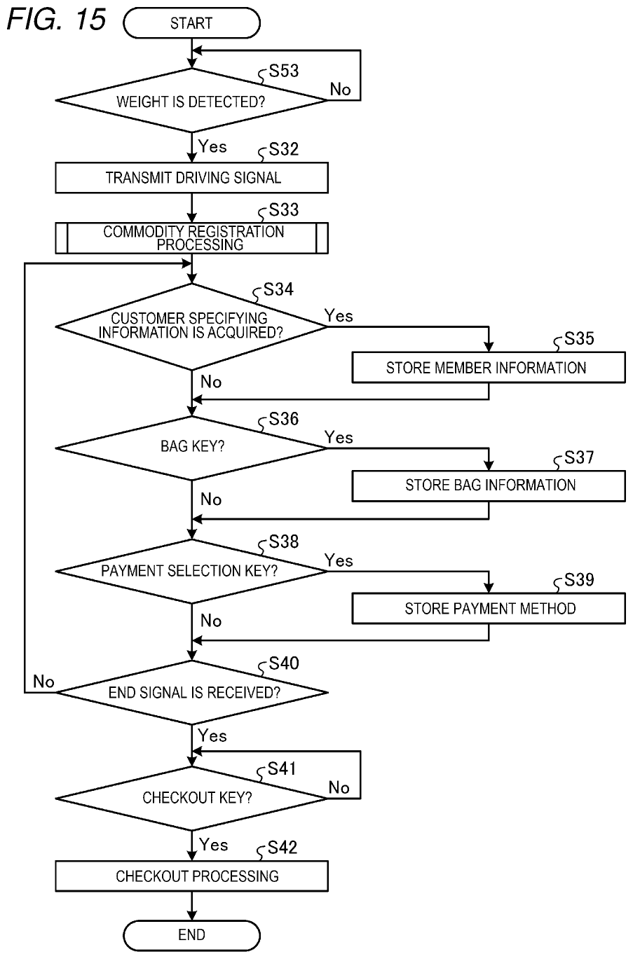

In the third embodiment, the reading device 30 does not include the second antenna 23 illustrated in FIG. 2. As illustrated in FIGS. 13 and 14, the reading device 30 includes a weight sensor 31. The weight sensor 31 detects the weight of the commodity M placed on the commodity placing table 6. The weight sensor 31 detects the weight of the commodity M or a basket storing the commodity M placed on the commodity placing table 6 and outputs a trigger signal indicating that the commodity M or the basket storing the commodity M is placed on the commodity placing table 6. In the third embodiment, the reading device 30 executes the processing illustrated in FIG. 11 as in the second embodiment. As illustrated in FIG. 15, as processing in Act 53, the control unit 400 of the self-service checkout device 1 determines whether a signal indicating that the weight sensor 31 detected the weight of the commodity M or the basket storing the commodity M placed on the commodity placing table 6 is received (Act 53). The control unit 400 stays on standby until the signal indicating that the weight sensor 31 detected the weight is received (NO in Act 53). If determining that the signal indicating that the weight sensor 31 detected the weight is received (that is, if determining that the trigger signal is received) (Yes in Act 53), the control unit 400 transmits a driving signal to the reading device 30 (Act 32).

As explained above, the self-service checkout device 1 in the third embodiment includes the first antenna 22 that is capable of moving in a predetermined distance and reads tag information from the wireless tag T attached to the commodity M, the first processing unit 401 that, if receiving a trigger signal generated by the weight sensor 31 detecting the weight, moves the first antenna 22 and performs commodity registration processing for the commodity M based on the read tag information, and the second processing unit 402 that performs other processing relating to operation in parallel to the commodity registration processing performed by the first processing unit 401.

In such a self-service checkout device 1 in the third embodiment, if receiving the trigger signal generated by the weight sensor 31 detecting the weight of the commodity M or the basket storing the commodity, the control unit 400 performs the commodity registration processing of (2) and at least one processing among the processing of (3), the processing of (4), and the processing of (5) illustrated in FIG. 9 in parallel. Therefore, it is possible to reduce a time of register processing required for one customer.

As a modification of the third embodiment, for example, an optical sensor may be provided instead of the weight sensor 31. The optical sensor may detect that the commodity M or the basket storing the commodity M is placed on the commodity placing table 6 and output a trigger signal. In this case, in the determination in Act 53, the control unit 400 determines whether the trigger signal output from the optical sensor by detecting the commodity M or the basket is received.

As another modification of the third embodiment, for example, a camera that images the commodity placing table 6 from above may be provided instead of the weight sensor 31 and the optical sensor. The camera may output a trigger signal if the camera images the commodity M or the basket storing the commodity M placed on the commodity placing table 6. In this case, in the determination in Act 53, the control unit 400 determines whether the trigger signal output by the camera imaging the commodity M or the basket is received.

While the embodiments of the present disclosure are explained above, the embodiments are presented as examples and are not intended to limit the scope of the invention. These new embodiments can be implemented in other various forms. Various omissions, substitutions, and changes can be made without departing from the gist of the invention. The embodiments and the modifications thereof are included in the scope and the gist of the invention and included in the inventions described in the claims and the scope of equivalents of the inventions.

For example, in the first embodiment, the trigger signal is output if the second antenna 23 reads the tag information. However, not only this, but the trigger signal may be output if, instead of the second antenna 23, the first antenna 22 reads the tag information. In this case, the second antenna 23 is unnecessary.

In the embodiments, the display is performed respectively in the processing in Act 35, the processing in Act 37, the processing in Act 39, and the processing in Act 333. However, not only this, but, for example, the display may not be performed in the processing in Act 35, the processing in Act 37, the processing in Act 39, and the processing in Act 333 and, if it is determined Yes in Act 41, the display in the processing in Act 35, the processing in Act 37, the processing in Act 39, and the processing in Act 333 may be collectively performed before the processing in Act 42. In this case, it is possible to check a state of operation (for example, presence or absence, a size, and the number of bags) before performing the checkout processing.

In the embodiments, the self-service checkout device 1 is explained as an example of the checkout device. However, not only this, but the checkout device may be a normal POS terminal operated by a store clerk.

In the embodiments, the first antenna 22 reciprocates between the position of x=0 and the position of x=W. However, not only this, but the first antenna 22 may move, for example, from the position of x=0 to the position of x=W or from the position of x=W to the position of x=0.

In the embodiments, as the other processing relating to the operation performed by the second processing unit, the member processing for reading a member card and storing customer specifying information, the processing for storing, based on input information concerning necessity of a bag, a size and the number of bags to be purchased, and the processing for storing a selected payment method are performed. However, these kinds of processing are examples of the other processing relating to operation and may be processing other than these kinds of processing if the processing is the other processing relating to operation.

In the case of the modifications of the first embodiment, the second embodiment, and the third embodiment, the commodity M or the basket storing the commodity M is placed on the commodity placing table 6. However, not only this, but the commodity placing table 6 may not be provided and a shopping cart storing a commodity may be located in the position of the commodity placing table 6. In this case, the reading device 30 is provided in a position where the reading device 30 can read tag information transmitted by a wireless tag attached to the commodity stored in the shopping cart (for example, a position adjacent to the shopping cart).

The programs executed by the self-service checkout device 1 in the embodiments may be provided by being recorded in a computer-readable recording medium such as a CD-ROM, a flexible disk (FD), a CD-R, or a DVD (Digital Versatile Disk) as a file of an installable format or an executable format.

The programs executed by the self-service checkout device 1 in the embodiments may be stored on a computer connected to a network such as the Internet and may be provided by being downloaded through the network. Further, the programs executed by the self-service checkout device 1 in the embodiments may be provided or distributed through a network such as the Internet.

The programs executed by the self-service checkout device 1 in the embodiments may be incorporated in a ROM or the like in advance and provided.

What is claimed is:

1. A checkout device, comprising:
a first antenna configured to move a predetermined distance and read tag information from a wireless tag attached to a commodity;
a first processing component configured to, if receiving a trigger signal, move the first antenna and perform commodity registration processing for the commodity based on the read tag information; and
a second processing component configured to perform other processing relating to an operation in parallel to the commodity registration processing performed by the first processing component.

2. The checkout device according to claim 1, further comprising a second antenna near a placing table on which the commodity is placed, wherein
the trigger signal is a signal indicating that the second antenna reads the tag information.

3. The checkout device according to claim 2, further comprising a reading device comprising the first antenna the second antenna.

4. The checkout device according to claim 2, wherein the second antenna has a weaker transmission power than the first antenna.

5. The checkout device according to claim 1, wherein the trigger signal is a signal indicating that a start key for starting operation of the checkout device is operated.

6. The checkout device according to claim 1, wherein
the checkout device is a self-service checkout device operated by a customer, and
the second processing component performs the other processing based on the operation of the customer.

7. The checkout device according to claim 1, wherein the second processing component performs, as the other processing relating to the operation, at least one processing among:
storage of input customer specifying information,
storage of input information concerning a bag, and
storage of a selected payment method.

8. The checkout device according to claim 1, wherein the checkout device is a self service checkout device.

9. A checkout method for a checkout device including a first antenna configured to move a predetermined distance and read tag information from a wireless tag attached to a commodity, the checkout method comprising:
if receiving a trigger signal, moving the first antenna and performing commodity registration processing for the commodity based on the read tag information; and
performing other processing relating to an operation in parallel to the performed commodity registration processing.

10. The checkout method according to claim 9, wherein the checkout device further comprises a second antenna near a placing table on which the commodity is placed, and the trigger signal is a signal indicating that the second antenna reads the tag information.

11. The checkout method according to claim 10, wherein the second antenna has a weaker transmission power than the first antenna.

12. The checkout method according to claim 9, further comprising:
performing, as the other processing relating to the operation, at least one processing among:
storing of input customer specifying information,
storing of input information concerning a bag, and
storing of a selected payment method.

13. A point of sales terminal, comprising:
a payment processing component;
a first antenna configured to move a predetermined distance and read tag information from a wireless tag attached to a commodity;
a first processing component configured to, if receiving a trigger signal, move the first antenna and perform commodity registration processing for the commodity based on the read tag information; and
a second processing component configured to perform other processing relating to an operation in parallel to the commodity registration processing performed by the first processing component.

14. The point of sales terminal according to claim 13, further comprising a second antenna near a placing table on which the commodity is placed, wherein
the trigger signal is a signal indicating that the second antenna reads the tag information.

15. The point of sales terminal according to claim 14, further comprising a reading device comprising the first antenna the second antenna.

16. The point of sales terminal according to claim 14, wherein the second antenna has a weaker transmission power than the first antenna.

17. The point of sales terminal according to claim 13, wherein the trigger signal is a signal indicating that a start key for starting operation of the checkout device is operated.

18. The point of sales terminal according to claim 13, wherein
the checkout device is a self-service checkout device operated by a customer, and
the second processing component performs the other processing based on the operation of the customer.

19. The point of sales terminal according to claim 13, wherein the second processing component performs, as the other processing relating to the operation, at least one processing among:
storage of input customer specifying information,
storage of input information concerning a bag, and
storage of a selected payment method.

20. The point of sales terminal according to claim 13, wherein the checkout device is a self service point of sales terminal.
